(19) United States
(12) Patent Application Publication
(10) Pub. No.: US 2003/0181284 A1
(43) Pub. Date: Sep. 25, 2003

(54) Planet-gear speed reducer

(76) Inventor: Tai-Shan Chen, Hsin Chuang City (TW)

Correspondence Address: Jones, Tullar & Cooper, P.C., Suite 1002, 2001 Jefferson Davis Highway, Arlington, VA, 22202, US

(21) Appl. No.: 10/101,348

(22) Filed: Mar. 20, 2002

(51) Int. Cl. F16H 57/08

(52) U.S. Cl. 475/331

(57) ABSTRACT

A planet-gear speed reducer includes a rotary carrier having a first end and a second end. The carrier has a plurality of equidistant spacers extending outward from the first end and a wheel gear formed at the second end. The carrier is further formed with a plurality of first radial slots defined in the first end among the spacers. A cap is attached to distal ends of the spacers, and formed with a plurality of second radial slots aligned with the first radial slots of the carrier. Additionally, a plurality of planetary gears is received in spacings between the spacers, with each planetary gear formed with a central spindle rotatable relative thereto. The central spindle has a pair of opposed ends movable along corresponding slots of the carrier and the cap.

### BACKGROUND OF THE INVENTION

1. Field of the Invention

The present invention relates to a planet-gear speed reducer and, more particularly, to a planet-gear speed reducer which is easy to be assembled.

2. Description of Related Art

The planet-gear speed reducer is widely used, for example, in a rotary door unit which, as shown in FIG. 4, has a rotary outer tube (15) which has one end connected to a door counter (11) and the other end supported on a spaced brackets (10) by a bearing for rolling up or down a door (not shown).

In the outer tube (15) there is a stationary inner tube (14) that houses a door counter (11), a motor (12) and a planet-gear speed reducer (13). Because the reducer (13) is formed with a wheel gear (18′) meshing with inner teeth of the rotary outer tube (15), the outer tube (15) will rotate whenever the gear (18′) is driven by the motor (12), through the speed reducer (13).

Referring to FIG. 5, the configuration of the planet-gear speed reducer of a conventional type is now to be described.

In detail, it includes a stationary tubular inner gear (16) having a toothed inner periphery (19). Situated in the inner gear (16) is a rotary carrier (40) that has an end formed with the wheel gear (18′) (shown in phantom line), and an opposed open end formed with three equidistant openings (41) for accommodating respective planetary gears (34′).

The carrier (40) further defines a pair of opposed radial slots (42) at sides of each opening (41). Each of the planetary gears (34′) is provided with a rotary spindle (35′) having a pair of chamfered ends (only one is shown) movable along the slots (42), so as to enable the spindles (35′) and hence the planetary gears to be moved radially inwardly and outwardly relative to the carrier (40).

These planetary gears (34′) mesh not only with the toothed inner periphery (19) of the stationary inner gear (16), but also with a central gear (not shown) that is driven directly by the motor (12). In this configuration, the rotary carrier (40) as well as the planetary gears (34′) will be rotated when the central gear rotates, as can be appreciated by those skilled in the art.

However, a problem rises that the speed reducer is not easy to be assembled, because one or more planetary gears (34′) tend to slip out of the openings (41) unwantedly when the carrier (40) with the gears (34′) is to be put into the tubular inner gear (19).

Therefore, it is an objective of the invention to provide a planet-gear speed reducer to mitigate and/or obviate the aforementioned problems.

### SUMMARY OF THE INVENTION

The object of the present invention is to provide a planet-gear speed reducer which is easy to be assembled.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a preferred embodiment of a planet-gear speed reducer in accordance with the present invention;

FIG. 2 is a cross-sectional view of the planet-gear speed reducer of FIG. 1;

FIG. 3 is an end view of the a planet-gear speed reducer of FIG. 1, with a cap removed;

FIG. 4 is a schematic view of a rotary door unit; and

FIG. 5 is an enlarged exploded perspective view of a convention planet-gear speed reducer used in the rotary door unit of FIG. 4.

### DETAILED DESCRIPTION OF THE PREFERRED EMBODIMENT

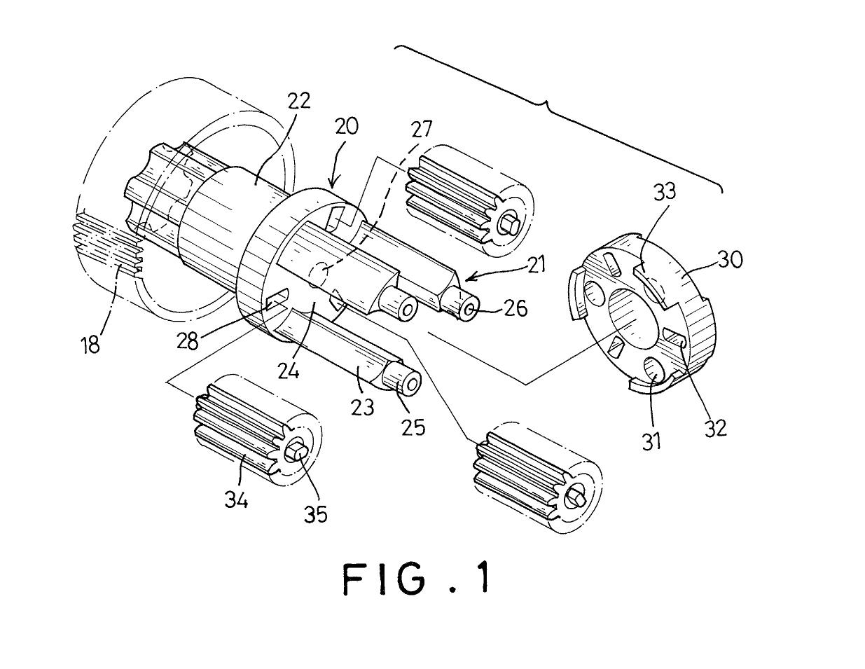

Referring to FIG. 1, there is shown a preferred embodiment of a planet-gear speed reducer in accordance with the present invention. The speed reducer includes a rotary carrier (20) having a first end (21) and a second end (22), with a wheel gear (18) formed at the second end (22) and a plurality of equidistant spacers (23) extending outward from the first end (21). The carrier (20) is further formed, in its first end (21), with a central hole (27) and a plurality of first radial slots (28) among the spacers (23).

Each of the spacers (23) has a distal end shaped as a stub (25) which has a bore (26) defined therein for a purpose to be described in detail hereinafter.

A cap (30) is attached to the distal ends or, to be more precise, the stubs (25) of the spacers (23). To this end, the cap (30) is formed with a plurality of apertures (31) that allow the stubs (25) to extend therethrough until the cap (30) is engaged with or stopped by shoulders (not numbered) associated with the stubs (25).

The cap (30) is further formed with a plurality of second radial slots (32) aligned with the first radial slots (28) of the carrier (20), and preferably a plurality of tabs (33) configured to engage radially outer faces of the spacers (23).

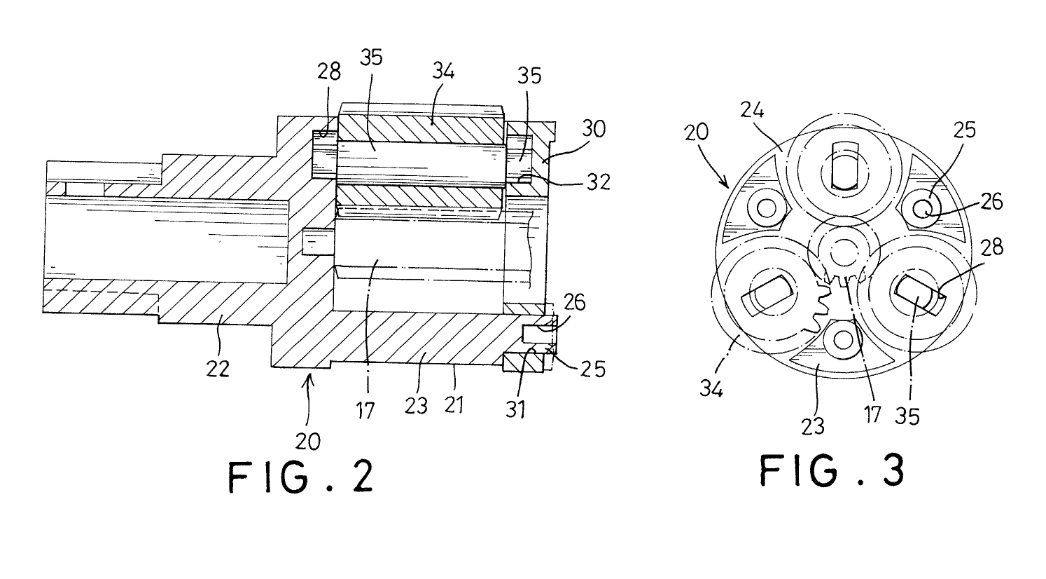

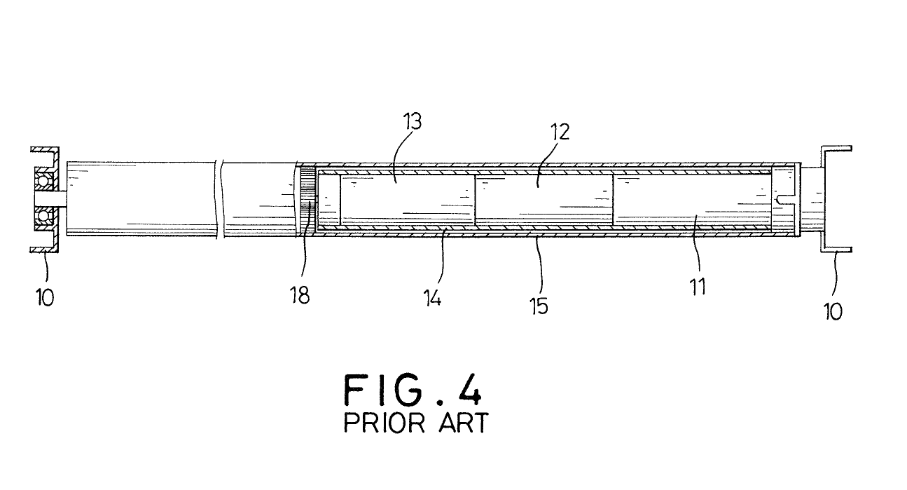

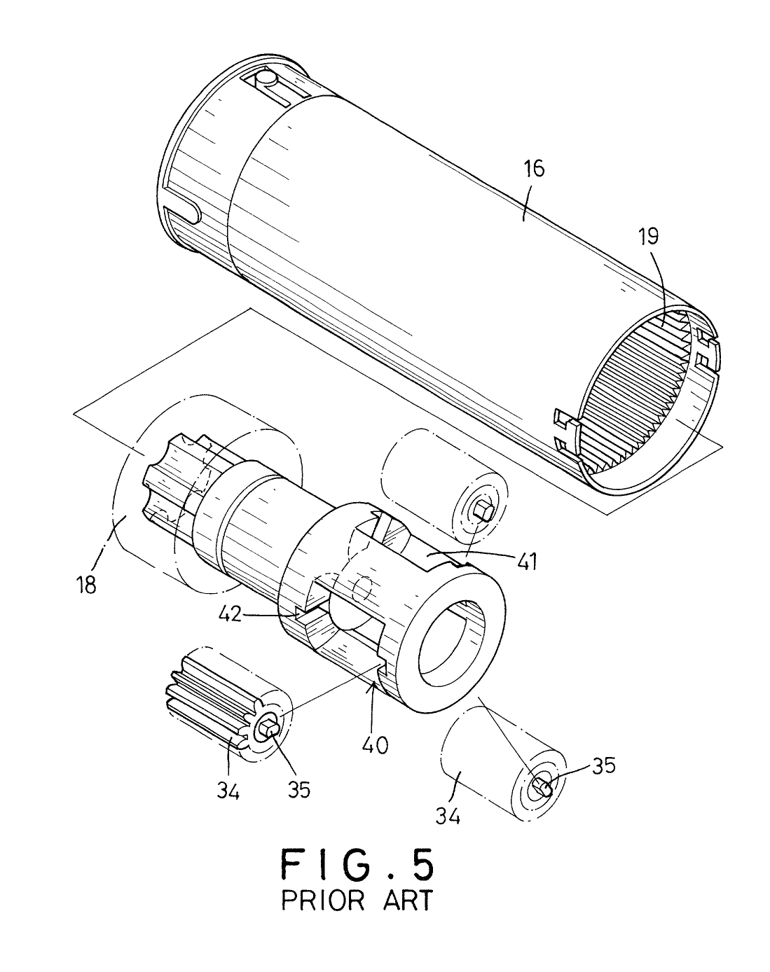

In this way the carrier (20), together with the cap (30), serves as a frame that defines several spacings (24) between the spacers (23) to receive a plurality of planetary gears (34), as best shown in FIGS. 2 and 3.

Referring to FIGS. 2 and 3, each of the planetary gears (34) is provided with a central spindle (35) rotatable relative thereto. Additionally, each spindle (35) has a pair of opposed ends, preferred chamfered in a manner as illustrated in FIG. 1, that are movable along corresponding slots (28, 32) of the carrier (20) and the cap (30), thereby allowing the spindles (35) and hence the planetary gears (34) to be slightly moved radially inwardly and outwardly with respect to the carrier (20) and the cap (30).

In fact, the inventive speed reducer is assembled by placing the planetary gears (34) in the spacings (24) among the spacers (23) before putting the chamfered ends of the spindles (35) into the first radial slots (28) of the carrier (20).

The cap (30) is then attached to the spacers (23), with the other chamfered ends of the spindles (35) inserted into the second radial slots (35) and the stubs (25) of the spacers (23) extending into the apertures (31) of the cap (30), which is now engaged with or stopped by the shoulder associated with the stubs (25), as clearly shown in FIG. 2.

The attachment of the cap (30) to the spacers (23) may be secured in many ways. For example, those parts of the stubs (25) extending through the cap (30) may be enlarged by flaring said bores (26) of said stubs (25) in the manner of hammering a pin (not shown) that has a tip put in the bore (26). As a result, the planetary gears (24) are confined in the spacings (24) without any risk of coming out, as clearly shown in FIG. 3.

The planetary gears (34) are designed to be driven by a central gear (17) that meshes with them. The central gear (17) has a projected end rotatably supported in the central hole (27) of the carrier (20). When the central gear (17) is driven, such as by a motor, all of the planetary gears (34) are rotated, and so is the rotary carrier (20).

From the above description, it is noted that the invention has the advantages of being easy to be assembled, because the confinement of the planetary gears (34) in the carrier (20) enables them (20, 34) to be put into a tubular inner gear easily.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A planet-gear speed reducer comprising:
a rotary carrier (20) having a first end (21) and a second end (22), said carrier (20) having a plurality of equidistant spacers (23) extending outward from said first end (21) and a wheel gear (18) formed at said second end (22);
said carrier (20) being formed with a plurality of first radial slots (28) defined in said first end (21) among said spacers (23);
a cap (30) attached to distal ends of said spacers (23), said cap being formed with a plurality of second radial slots (32) aligned with said first radial slots (28) of said carrier (20); and
a plurality of planetary gears (34) received in spacings (24) between said spacers (23), each planetary gear (34) being formed with a central spindle (35) rotatable relative thereto, said central spindle (35) having a pair of opposed ends movable along corresponding slots (28, 32) of said carrier (20) and said cap (30).

2. The planet-gear speed reducer as claimed in claim 1, wherein said spacers (23) have respective stubs (25) formed at said distal ends thereof, and wherein said cap (30) has a plurality of through-holes (31) for allowing said stubs (25) to extend therethrough in such a way that said cap (30) is engaged with shoulders of said spacers (23) associated to said stubs (25).

3. The planet-gear speed reducer as claimed in claim 2, wherein each of said stubs (25) of said spacers (23) has a bore (26) defined therein, and wherein those parts of said stubs (25) extending through said cap (30) are enlarged by flaring said bores (26) of said stubs (25), thereby securing the attachment of said cap (30) to said spacers (23) of said carrier (20).

4. The planet-gear speed reducer as claimed in claim 1, wherein said cap (30) is further formed with a plurality of tabs (33) configured to engage radially outer faces of said spacers (23) of said carrier (20).
